(19) United States
(12) Patent Application Publication
(10) Pub. No.: US 2007/0082523 A1
(43) Pub. Date: Apr. 12, 2007

(54) Backing sheet for a die for a foil stamping machine

(75) Inventor: Glenn Lawrence Wright, Arcadia (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TMS Technologies Inc., Arcadia (AU)

(21) Appl. No.: 11/543,003

(22) Filed: Oct. 3, 2006

(30) Foreign Application Priority Data
Oct. 7, 2005 (AU) 2005905557

(51) Int. Cl. H01R 29/00

(52) U.S. Cl. 439/170

(57) ABSTRACT

A die (10) for a foil stamping machine. The die (10) includes a backing plate (11) of steel and an image layer (13) fixed to the plate (11) by means of an adhesive layer (12). The plate (11) is generally flat and is provided with a plurality of slots (14 and 15). The slots (14 and 15) are arranged in sets, the first set consisting of rows (16) and the second set consisting of rows (17). The rows (16) are generally normal to the rows (17).

### TECHNICAL FIELD

The present invention relates to backing sheets for foil stamping machines and more particularly but not exclusively to steel backing sheets to support an image layer.

### BACKGROUND OF THE INVENTION

The present invention relates to the field of graphic arts and more particularly to die plates employed on foil stamping machines, the field being generally discussed in U.S. Pat. No. 5,904,096 as well as International Patent Publications WO 00/67953, WO 02/085574, WO 02/086625, WO 03/057487 and WO 2005/023546.

Steel backing sheets (plates) expand as a result of heat being applied thereto. Unfortunately the layers applied to the backing plate expand at a different rate, which frequently causes “bowing” and shearing of the die assembly. This detracts from the quality of the product.

WO 2005/023546 addresses the problem of photopolymer dies delaminating, by providing passages in the steel back. The passages being punched or drilled so as to be generally circular in configuration. This arrangement partly overcame the problem of delaminating.

### OBJECT OF THE INVENTION

It is the object of the present invention to overcome or substantially ameliorate the above disadvantage.

### SUMMARY OF THE INVENTION

There is disclosed herein a backing plate for a foil stamping machine, said backing plate having a thickness and including:

a first major surface;

a second major surface, the second surface being generally parallel to the first surface but spaced therefrom by said thickness; and

a plurality of slots extending inwardly of the plate from said first surface.

Preferably, said slots extend from said first surface to said second surface.

Preferably, said slots are arranged in a first set of slots and a second set of slots, with the slots of each set being arranged in linear rows so that the slots in each row extend longitudinally in the direction of the row, with said first set extending generally perpendicular to said second set.

Preferably, the slots are arranged so that slots do not intersect.

Preferably, the rows of said first set are generally parallel and transversely spaced by equal distances, with the rows of said second set also being generally parallel and transversely spaced by equal distances.

Preferably, each slot has a length of 0.1 mm to 10 mm.

Preferably, said plate is formed from iron.

Preferably, said plate is formed from steel.

### BRIEF DESCRIPTION OF THE DRAWINGS

A preferred form of the present invention will now be described by way of example with reference to the accompanying drawings wherein:

FIG. 1 is a schematic sectioned side elevation of a portion of a die for a foil stamping machine; and

FIG. 2 is a schematic plan view of a steel backing plate employed in the die of FIG. 1.

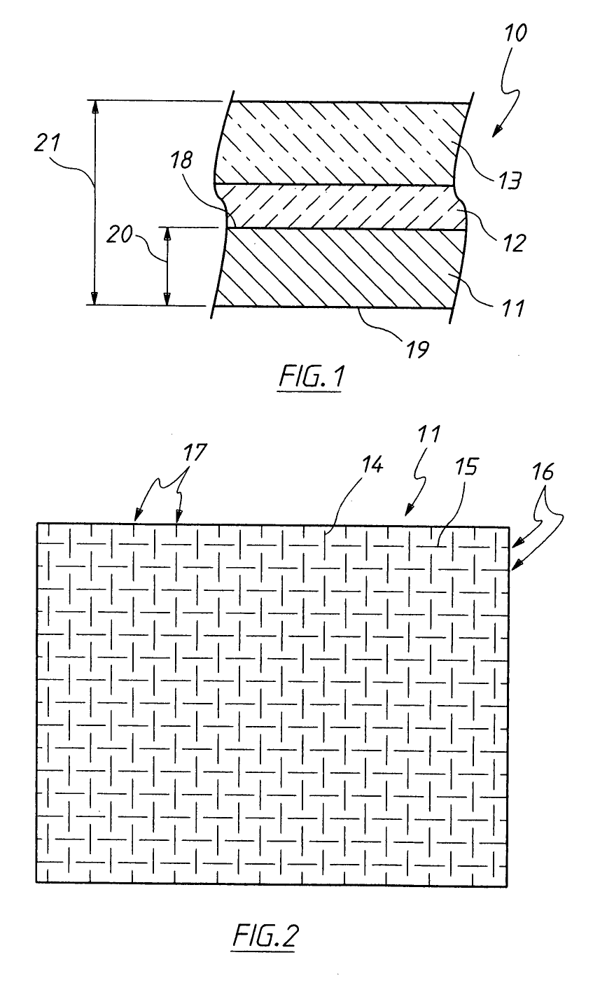

### DETAILED DESCRIPTION OF THE PREFERRED EMBODIMENT

In the accompanying drawings there is schematically depicted a die 10 for a foil stamping machine. In this embodiment the die 10 includes a backing plate 11 that is formed of iron or steel. Attached to the backing plate 11 is an image layer 13 by means of an adhesive layer 12. As an example, the adhesive layer 12 is a compressible adhesive such as an acrylic polymer or a phenolic resin. The image layer 13 may be formed from metal, such as brass, steel, copper, zinc, aluminium or magnesium, however the image layer may also be a photo-polymer.

The steel backing plate 11 of this embodiment is generally flat. However it should be appreciated the plate 11 may also be arcuate, that is, circular (cylindrical) in configuration.

The plate 11 has a plurality of slots 14 and 15. The slots 14 and 15 are arranged in sets, the first set consisting of rows 16 and the second set consisting of rows 17. The rows 16 are parallel and transversely equally spaced. Similarly the rows 17 are generally parallel and transversely equally spaced. In this respect it should be appreciated the slots 14 and 15 are longitudinally elongated in the direction of their respective row 16, 17 and are equally spaced. The rows 16 are normal to the rows 17, however the slots 14 and 15 do not individually intersect.

Preferably, the spacing between the rows 16 is equal to the spacing between the rows 17.

Preferably, the plate 11 has a first major surface 18 and a second major surface 19 that is spaced from the surface 18 by the thickness 20 of the plate 11. The slots 14 and 15 extend inwardly of the plate 11 from the surface 18 so as to engage the adhesive 12. More preferably the slots 14 and 15 extend through the plate 11, that is, from the surface 18 to the surface 19. Accordingly the adhesive 12 enters the slots 14 and 15 to bind the image layer to the plate 11. Preferably the surfaces are co-extensive.

Each slot 14, 15 has a transverse width of about 0.1 mm to about 0.3 mm, preferably about 0.2 mm, and a longitudinal length of 8 mm to 12 mm, preferably about 10 mm. Typically the distance between adjacent slots 14 and 15 is 2 mm to 3 mm, preferably 2.5 mm.

Preferably, the laminated die 10 has a thickness of about 1 mm to about 3 mm.

Use of the abovementioned slots 14 and 15 absorbs the expansion between the different metals to inhibit “bowing” of the die 10 and shearing.

1. A backing plate for a foil stamping machine, said backing plate having a thickness and including:
a first major surface;
a second major surface, the second surface being generally parallel to the first surface but spaced therefrom by said thickness; and
a plurality of slots extending inwardly of the plate from said first surface.

2. The plate of claim 1, wherein said slots extend from said first surface to said second surface.

3. The plate of claim 1, wherein said slots are arranged in a first set of slots and a second set of slots, with the slots of each set being arranged in linear rows so that the slots in each row extend longitudinally in the direction of the row, with said first set extending generally perpendicular to said second set.

4. The plate of claim 3, wherein the slots are arranged so that slots do not intersect.

5. The plate of claim 3, wherein the rows of said first set are generally parallel and transversely spaced by equal distances, with the rows of said second set also being generally parallel and transversely spaced by equal distances.

6. The plate of claim 1, wherein each slot has a length of 0.1 mm to 10 mm.

7. The plate of claim 1, wherein said plate is formed from iron.

8. The plate of claims 1, wherein said plate is formed from steel.

9. The plate of claim 2, wherein said slots are arranged in a first set of slots and a second set of slots, with the slots of each set being arranged in linear rows so that the slots in each row extend longitudinally in the direction of the row, with said first set extending generally perpendicular to said second set.

10. The plate of claim 9, wherein the slots are arranged so that slots do not intersect.

11. The plate of claim 10, wherein the rows of said first set are generally parallel and transversely spaced by equal distances, with the rows of said second set also being generally parallel and transversely spaced by equal distances.

12. The plate of claim 11, wherein each slot has a length of 0.1 mm to 10 mm.

13. The plate of claim 12, wherein said plate is formed from iron.

14. The plate of claims 13, wherein said plate is formed from steel.
